(19) United States
(12) Patent Application Publication
(10) Pub. No.: US 2011/0036435 A1
(43) Pub. Date: Feb. 17, 2011

(54) WATER-CARRYING DOMESTIC APPLIANCE

(75) Inventors: Werner Haltmayer, Dinkelsbuhl (DE); Anton Oblinger, Gersthofen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, Munich (DE)

(21) Appl. No.: 12/844,855

(22) Filed: Jul. 28, 2010

(30) Foreign Application Priority Data
Aug. 17, 2009 (DE) 10 2009 028 588.1

(51) Int. Cl. F16K 24/00

(52) U.S. Cl. 137/872

(57) ABSTRACT

A water-conveying domestic appliance having at least one water inlet pipe to supply the domestic appliance with water from a water network. A backflow prevention apparatus is connected in the water inlet pipe, enables water supply only in the direction of the domestic appliance, and prevents a backflow of water in the direction of the water network.

### BACKGROUND OF THE INVENTION

The invention relates to a water-carrying domestic appliance, for instance a domestic dishwasher or a domestic washing machine.

Water-carrying domestic appliances, such as dishwashers or washing machines for instance, comprise water connections, with which the domestic appliances can be connected to the fresh water network for instance. If such a domestic appliance is connected to the water network by way of a water inlet pipe, it is then possible for water in the water inlet pipe to flow back into the water network.

### BRIEF SUMMARY OF THE INVENTION

The object of the invention is to embody a domestic appliance such that it prevents water in a water inlet pipe of the domestic appliance from reaching the water network.

The object of the invention is achieved by a water-carrying domestic appliance, comprising at least one water inlet pipe for supplying the domestic appliance with water from a water network and a return flow prevention apparatus, which is connected in the water inlet pipe and is set up to only enable a water flow in the direction of the domestic appliance, but to prevent a water backflow in the direction of the water network. The inventive domestic appliance is a dishwasher or a washing machine for instance.

In accordance with the invention, the domestic appliance accordingly includes the backflow prevention apparatus which is connected in the water inlet pipe of the domestic appliance, said backflow prevention apparatus only enabling water flowing through the water inlet pipe to flow in an inflow direction, namely from the water network toward the domestic appliance. As a result of the backflow prevention apparatus preventing a flow direction of the water in the water inlet pipe away from the domestic appliance, in particular to the water network, requirements in terms of preventing water in the water inlet pipe from flowing back into the water network are created.

The inventive domestic appliance can preferably include several water inlet pipes for supplying the domestic appliance with water from the water network, with each of the water inlet pipes preferably comprising a backflow prevention apparatus, which is connected in the relevant water inlet pipe and is set up to only enable water to flow in the direction of the domestic appliance but to prevent water from flowing back in the direction of the water network. Such an embodiment can then be provided for instance if the inventive domestic appliance is to be supplied with cold and preheated water. It is then possible for one of the water inlet pipes to be connected to a cold water connection and the other to be connected to a warm or hot water connection.

The water inlet pipe and/or the water inlet pipes can be embodied as a water hose and/or as water hoses. In particular, if the water hose is embodied in a flexible manner, the connection convenience of the inventive domestic appliance to the water network then increases.

The water hose can preferably run within a jacket tube. If the water hose is not tight for instance, the jacket tube can collect escaping water.

According to a preferred variant of the inventive domestic appliance, the water inlet pipe can be connected to the water network by means of an inlet valve. The inlet valve is a magnetic valve for instance, which can be opened and closed by a control apparatus of the inventive domestic appliance for instance, in order to control the water inlet of the inventive domestic appliance for instance. The backflow prevention apparatus is set up accordingly for this variant in order to prevent water from flowing in the direction of the inlet valve.

The inlet valve and the water inlet pipe can preferably form a waterstop system. If applicable, this then comprises a safety mechanism in order to prevent the water inlet in the case of a fault in particular in the water hose and/or water hoses for instance, by the control apparatus automatically blocking the inlet valve/s for instance

According to a preferred embodiment of the inventive domestic appliance, the backflow prevention apparatus is embodied as a non-return valve. A non-return valve is set up to automatically close the passage of the water flowing therethrough in a flow direction, in other words in the direction of the water network. The non-return valve may be a spring-loaded non-return valve for instance, in which a closing element is closed in the direction of the water network by means of a spring, and is by contrast released in the direction of the domestic appliance by the water flowing through the water inlet pipe, if necessary through the water hose. A ball, taper, flap or membrane can be used as a closing element for instance, which presses against an entry and/or exit of a flow-through duct of the non-return valve by means of the spring.

If necessary, the inventive domestic appliance accordingly provides a non-return barrier, particularly in the case of dishwashers with a warm or cold water connection, in particular for the possibility of using solar heat. On account of the installation and/or insertion of the backflow prevention apparatus, in particular in the form of the non-return valve in each water inlet pipe, a backflow of water in the respective water inlet pipe into the water network is prevented. In particular, with the use of the non-return valve, the inventive domestic appliance can be realized relatively cost-effectively. No complicated modifications of a waterstop valve, in particular aquastop valve are needed, which is provided if necessary at the upstream and/or inlet end of each water inlet pipe.

The invention accordingly relates if applicable to a non-return valve for preventing backflow, which is integrated in the water inlet of a domestic appliance having one and/or two water inlet pipes (warm and cold water).

Other embodiments and developments of the invention are reproduced in the sub claims. The advantageous embodiments and developments of the invention which are explained above and/or reproduced in the sub claims can be used here individually or also in any combination with one another in the case of the inventive dishwasher.

### BRIEF DESCRIPTION OF THE DRAWINGS

The invention and its embodiment and development as well as its advantages are explained below with the aid of drawings, in which:

FIG. 1. shows a schematic representation of a domestic dishwasher with an inventively embodied water inlet facility, and

FIG. 2 shows a schematic representation of the water inlet system of the domestic dishwasher.

### DETAILED DESCRIPTION OF EXEMPLARY EMBODIMENTS OF THE PRESENT INVENTION

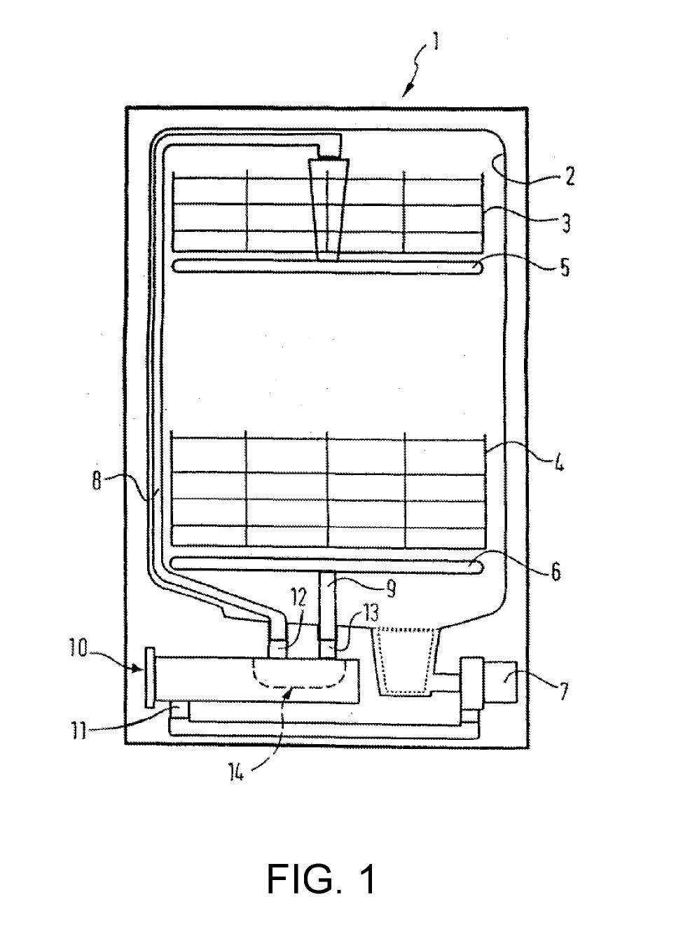

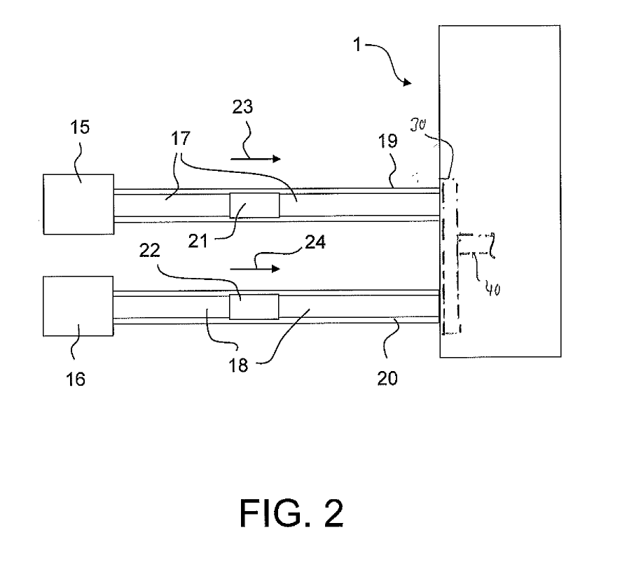

Elements with the same function and mode of operation are provided with the same reference characters in FIGS. 1 and 2 respectively.

FIG. 1 shows a cut-out representation of a domestic dishwasher 1 as an example of a water-carrying domestic appliance.

The domestic dishwasher 1 has a washing compartment 2 for receiving items to be washed, which can be arranged in an upper dish rack 3 and a lower dish rack 4 for instance. At least two spray apparatuses for applying the item to be washed with a liquid are arranged in the washing compartment 2, said liquid usually being referred to as washing liquor. In the event of the present exemplary embodiment, the spray apparatuses are embodied as upper and lower spray arms 5, 6. The liquid can be delivered by a circulating pump 7, via a first liquid feed line 8 to the upper spray arm 5 and via a second liquid feed line 9 to the lower spray arm 6. The circulating pump 7 is powered for instance by means of an electrical drive (not shown in further detail) in particular by means of its electrical motor.

In the case of the present exemplary embodiment, the liquid is heated at least in a sub program step of a washing program of the domestic dishwasher 1 by means of a flow-through water heater 10, which is connected to an inlet connection 11 on the circulating pump 7 and to outlet connections 12, 13 on the liquid feed lines 8, 9. The number of outlet connections 12, 13 corresponds to the number of spray arms 5, 6 or simultaneously operated groups of spray arms 5, 6. The liquid delivered by the circulating pump 7 is accordingly routed, in the case of the present exemplary embodiment, to the inlet connection 11 of the flow-through water heater 10 and from its outlet connections 12, 13 via the liquid feed lines 8, 9 to the spray arms 5, 6.

The domestic dishwasher 1 also has a water switch 14, which is arranged in the flow-through water heater 10 or is molded thereon for instance. The water switch 14 can however also be arranged in the domestic dishwasher 1 or can be directly connected to the circulating pump 7 for instance.

The water switch 14 enables each of the spray arms 5, 6 to be fed alternately and/or continuously with the liquid. This is achieved by opening a liquid outlet and by closing another liquid outlet of the water switch 14.

FIG. 2 shows a water inlet system of the domestic dishwasher 1.

In the case of the present exemplary embodiment, the water inlet system includes several water connections in particular in the form of a first inlet valve 15 and a second inlet valve 16. The inlet valves 15, 16 are for instance magnetic valves and are connected to a control apparatus of the domestic dishwasher 1 (not shown), which is configured inter alia to control the operation of the domestic dishwasher 1 and to open and close inlet valves 15, 16. The two inlet valves 15, 16 are provided so as to be connected to a water network (not shown in further detail). One of the inlet valves 15, 16 can be connected to a cold water connection for instance and the other to a warm or hot water connection of the water network in order to supply the domestic dishwasher 1 with cold or preheated water.

The water inlet system of the domestic dishwasher 1 includes, in the case of the present exemplary embodiment, two water feed lines, e.g. in the form of a first water hose 17, which is connected to the first inlet valve 15, and a second water hose 18, which is connected to the second inlet valve 16. The ends of the water hoses 17, 18 facing away from the inlet valves 15, 16 are connected to a device inlet of the domestic dishwasher 1. The water originating from the water connections reaches the washing compartment 2 by way of the device inlet, in order to form the washing liquor if combined with detergent.

The water inlet system can be embodied as a waterstop system and can accordingly include a safety mechanism, in order to prevent the water supply, in the event of a fault in the water hoses 17, 18, by the control apparatus automatically closing the inlet valves 15, 16 for instance. To this end, the two water hoses 17, 18 can also run within jacket tubes 19, 20, which are conduit pipes for instance. The water hoses 17, 18 are not tight and the jacket tubes 19, 20 can therefore collect escaping water.

To prevent water in the water hoses 17, 18 from flowing back in the direction of the inlet valves 15, 16 and if applicable back into the water network, a backflow prevention apparatus 21, 22 is connected to each of the water pipes 17, 18. The two backflow prevention apparatus 21, 22 are set up so that water in the water hoses 17, 18 can only flow in the direction of arrows 23, 24, in other words from the inlet valves 15, 16 in the direction of the device inlet, and not however in the counter direction, in other words in the direction of the inlet valves 15, 16.

The two backflow prevention apparatuses 21, 22 are embodied in each instance as non-return valves for instance. A non-return valve is set up to automatically close the passage of the water flowing through the relevant return valve in a flow direction, in the case of the present exemplary embodiment, in other words in the direction of the inlet valves 15, 16.

The non-return valves can be spring-loaded non-return valves for instance, in which a closing element is closed by a spring in the opposite direction of the arrows 23, 24, and is by contrast released by water flowing through the water hoses 17, 18. A ball, taper, flap or membrane can be used for instance as a closing element, which presses against an input and/or output of a flow-through duct of the non-return valve by means of the spring.

By a backflow prevention apparatus 21, 22 being provided in each of the inlet pipes 17, 18 between the inlet valves 15, 16 provided at the entry and/or connection side, in particular waterstop valves and/or aquastop valves, and the dishwasher 1, a backflow of water or washing liquor liquid out of the liquid circulation system of the dishwasher 1 in the direction of the aquastop valves 15, 16 is largely avoided by way of the backflow prevention apparatuses 21, 22. In particular, a cross-over and/or transverse backflow of water out of the one inflow pipe 18 into the other inflow pipe 17 (or vice versa) can be reliably prevented by the backflow prevention apparatuses 21, 22 inserted into the individual inlet and/or inflow pipes, if the two inflow pipes 17, 18 are connected on the output side to the two inputs of a pipe joining apparatus 30 and are guided into a shared introduction element 40, the output of which is connected to the liquid circulation system, in particular pump sump of the dishwasher. The pipe joining apparatus 30 and its introduction element 40 are shown with a dashed line in FIG. 2. It is therefore advantageously sufficient if the inlet valves 15, 16 on the entry side, in particular aquastop valves, are embodied such that they can only be closed in the inflow direction, i.e. it is not necessary for them to be embodied in the return direction, i.e. upstream and pressure-resistant to backflows.

What is claimed is:

1. A water-conveying domestic appliance, comprising:
at least one water inlet pipe to supply the domestic appliance with water from a water network; and
a backflow prevention apparatus connected in the water inlet pipe, the backflow prevention apparatus to enable a water supply only in a direction of the domestic appliance and to prevent a backflow of water in a direction of the water network.

2. The domestic appliance of claim 1, further comprising a plurality of water inlet pipes to supply the domestic appliance with water from the water network, wherein each of the plurality of water inlet pipes has a respective backflow prevention apparatus connected in a respective one of the plurality of water inlet pipes, the respective backflow prevention apparatus to enable the water supply only in the direction of the domestic appliance and to prevent the backflow of water in the direction of the water network.

3. The domestic appliance of claim 1, wherein the water inlet pipe is a water hose.

4. The domestic appliance of claim 3, further comprising a jacket tube, wherein the water hose runs within the jacket tube.

5. The domestic appliance of claim 1, further comprising an inlet valve to connect the water inlet pipe to the water network, wherein the backflow prevention apparatus prevents the backflow of water in the direction of the inlet valve.

6. The domestic appliance of claim 5, wherein the inlet valve and the water inlet pipe connected to the inlet valve form a waterstop system.

7. The domestic appliance of claim 1, wherein the backflow prevention apparatus is a non-return valve.

8. The domestic appliance of claim 1, wherein the domestic appliance is one of a domestic dishwasher and a washing machine.
